(19) United States
(12) Patent Application Publication
(10) Pub. No.: US 2013/0135608 A1
(43) Pub. Date: May 30, 2013

(54) APPARATUS AND METHOD FOR IMPROVED PROCESSING OF FOOD PRODUCTS

(71) Applicant: Reflectronics, Inc., Lexington, KY (US)

(72) Inventor: Fred A. Payne, Lexington, KY (US)

(73) Assignee: REFLECTRONICS, INC., Lexington, KY (US)

(21) Appl. No.: 13/690,822

(22) Filed: Nov. 30, 2012

Related U.S. Application Data
(60) Provisional application No. 61/565,091, filed on Nov. 30, 2011.

(51) Int. Cl. G01N 21/49

(52) U.S. Cl. CPC G01N 21/49
USPC 356/51; 356/342

(57) ABSTRACT

The light backscatter probe includes a housing carrying at least one optical transmission fiber and two optical reception or collecting fibers. The ends of the fibers are closed by a sapphire window. First and second light sources are provided for projecting incident light onto a product outside the sapphire window. The reception paths or fibers are located at different radial distances from the one optical transmission path to allow for measuring the coagulation of dairy products or determination of compositions of food products.

This utility patent application claims the benefit of priority in U.S. Provisional Patent Application Ser. No. 61/565,091 filed on Nov. 30, 2011, the entirety of the disclosure of which is incorporated herein by reference.

### TECHNICAL FIELD

This document relates generally to an apparatus and method for accurately monitoring a response or measuring a physical property during the processing of food products and more specifically dairy products processing including the steps of coagulation of milk; the status of the syneresis step; fat and protein content measurement in whey processing; measurement of fat in process liquid milk products; coagulation of milk in cultured products such as cottage cheese and yogurt.

### BACKGROUND OF THE INVENTION

Apparatus and methods for improving the processing of cheese products are well known in the art. U.S. Pat. No. 5,172,193 to Payne et al. discloses a particularly useful apparatus and method for this purpose. As disclosed in this document, light is directed from a light source toward milk undergoing enzymatic hydrolysis. In addition the method includes sensing diffused reflectance of the light from the milk at substantially 950±5 nm, analyzing the sensed diffuse reflectance profile of the light and signaling the cut time for the coagulum. While diffuse reflectance from the product surface does carry information about the property of the product, that information is relatively limited. Passing light through a product for a distance generally delivers more useful product information.

A direct contact optical fiber configuration has also been used in the past to measure changes in foods. As illustrated in FIG. 1, in such a configuration, the optical fiber F delivers light (note action arrow L₁) directly to the product with the optical fiber terminating at the product surface so there is no window-product interface. This method totally eliminates the collection of specular reflectance and diffuse reflectance from the product surface. Thus, any and all collected light is backscatter light that is passed through the product (see action arrow L₂). Such backscatter light provides the most useful information respecting product characteristics.

While a direct contact optical contact fiber configuration of the type described above and illustrated in FIG. 1 has the advantage that the light is delivered directly to the product, there are problems associated with a direct contact optical fiber configuration. The foremost challenge is in manufacture and more specifically the attaching of the optical fiber mechanically at the distal tip (typically a stainless steel material) in a manner that uses only materials approved for contact with foods and with an attachment mode that is compliant with sanitary standards. Because of these difficulties with the direct contact optical fiber configuration, an alternative optical configuration is desired while still maintaining the same performance characteristics.

A sapphire window offers advantages in that it is inert, extremely hard and durable and not effected by the caustic and acidic solutions used in wash cycles. Thus, a sapphire window does not change with time requiring a recalibration of the associated instruments. Additionally, the use of a sapphire window eliminates the problem relative to attaching a fiber to a distal tip material (typically a stainless steel material) in a manner that uses only materials approved for contact with foods and in an attachment mode that is compliant with sanitary standards. A disadvantage of an optical window, however, is that specular reflectance and diffuse reflectance are part of the measured light and these can reduce the sensitivity of a probe for product monitoring. See particularly FIG. 2 showing a probe J with a sapphire window W closing the ends of the transmission fiber T and the collecting fiber C. The area of specular and diffuse reflectance is illustrated at Z.

As described in this document it is now possible to use a thin sapphire window in combination with strategic positioning of the optical fibers to obtain a measurement with essentially no specular reflectance or diffuse reflectance. Further, this can be done while maximizing light intensity for greatest sensitivity. More specifically, the combination of relatively small optical fibers and a relatively thin sapphire window has enhanced the ability to implement different optical configurations and eliminate the need to attach the optic fiber mechanically at a distal tip.

### SUMMARY OF THE INVENTION

A light backscatter probe for monitoring a product comprises a housing carrying a first light transmission fiber and a first light collecting fiber. A light source is provided in communication with the first light transmission fiber. A light sensor or photodetector is provided in communication with the first light collecting fiber. A sapphire window is carried on the housing. The sapphire window closes ends of the first light transmission fiber and first light collecting fiber.

The first light transmission fiber projects light from the light source as a light cone through the sapphire window into the product being monitored. The first light collecting fiber collects backscatter light from the product in a detection cone passing through the sapphire window and converging toward the first light collecting fiber. The first light transmission fiber and first light collecting fiber are oriented so that the light cone and detection cone define a first point of overlap on a product side of the sapphire window. More specifically, the sapphire window includes a product face which contacts the product being monitored and the first point of overlap is on the product side of that face between 0.0 mm and 1.0 mm and more particularly between 0.0 mm and 0.5 mm from the product face. Such an arrangement effectively eliminates collection of specular reflectance and diffuse reflectance while maximizing the intensity of the backscatter light being collected. Thus, instrument sensitivity is maximized in a way that allows one to obtain the greatest possible amount of information respecting the product being monitored.

In accordance with additional aspects, a light backscatter probe comprises a housing, at least one optical transmission path carried on the housing, a first optical reception path carried on the housing and a second optical reception path carried on the housing. A first light source is provided in communication with the at least one optical transmission path. A second light source is provided in communication with the at least one optical transmission path. A first photodetector is provided in communication with the first optical reception path. A second photodetector is provided in communication with the second optical reception path. In addition the probe is further characterized by the first and second optical reception paths being located at different radial distances from the at least one optical transmission path on the housing.

More specifically, the light backscatter probe further includes a computing device to collect and analyze light backscatter data. The first light source generates light at a first wavelength and the second light generates light at a second wavelength where the first and second wavelengths differ but both are between 200 nm and 1,100 nm. In one possible embodiment the first and second wavelengths differ by at least 20 nm. In another possible embodiment the first and second light sources are alternately pulsed at a frequency of between 1 and 1,000 times per second.

A sapphire window may be carried on the housing with the window closing ends of the at least one optical transmission path, the first optical reception path and the second optical reception path. The sapphire window may be gold brazed to the housing.

In one useful embodiment the at least one optical transmission path includes a first light transmission fiber connected to the first light source and a second light transmission fiber connected to the second light source. In yet another useful embodiment the probe further includes a vessel and coagulating milk in the vessel. The housing is oriented relative to the vessel so that light transmitted from the first and second light sources through the at least one optical light transmission path impinges on the coagulating milk in the vessel and light backscattered by the coagulating milk is collected by the first and second optical reception paths and delivered to the first and second photodetectors.

In accordance with yet another aspect a method is provided for monitoring a food product such as coagulating milk in a cheese making process. The method may be broadly described as comprising the steps of impinging a first light of a first wavelength onto the coagulating milk, detecting light backscatter from the coagulating milk at the first wavelength at two different positions where the two different positions are different radial distances from a first point of transmission of the first light. The method further includes impinging a second light at a second wavelength onto the coagulating milk, detecting light backscatter from the coagulating milk at the second wavelength at two different positions where the two different positions are different radial distances from a second point of transmission of the second light. Still further the method may include analyzing light backscatter data and predicting cut time for the coagulating milk. More specifically the method includes impinging and detecting through a sapphire window. This may be done by using a single optical transmission path so that the first and second transmission points are the same. Alternatively it may be done including using two separate optical transmission paths so that the first and second transmission points are different.

In accordance with yet another aspect a method of monitoring coagulating milk in a cheese making process comprises pulsing light on the coagulating milk at two different wavelengths and detecting backscatter of the pulsed light at two different radial distances from the point of transmission of the pulsed light. Still further the method includes analyzing light backscatter data and predicting cut time for the coagulating milk. In one embodiment the method includes pulsing and detecting the light through a sapphire window. In one embodiment the method includes using a first light at a first wavelength of between 200 nm and 1100 nm and using a second light at a second wavelength of between 200 nm and 1100 nm where the first and second wavelengths differ by at least 20 nm. In one embodiment the method includes pulsing the lights of different wavelengths at a frequency of between 1 and 1,000 times per second.

In the following description there shown and described several different embodiments for a light backscatter probe and a method for monitoring a food product such as coagulating milk in a cheese making process. As it should be realized, the probe and method are capable of other different embodiments and their several details are capable of modification in various, obvious aspects. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the current light backscatter probe and together with the description serve to explain certain principles of the probe. In the drawings:

FIG. 1 is a schematic illustration of the direct contact optical fiber configuration of the prior art;

FIG. 2 illustrates a probe with a sapphire window showing the area of specular and diffuse reflectance;

FIG. 3 is a schematical illustration of a probe including a sapphire window constructed in accordance with the teachings presented in this document so as to eliminate specular and diffuse reflectance and provide for the collecting of backscatter light with optimum sensitivity and signal to noise ratio;

FIG. 4 is a schematical illustration of a light backscatter probe with a single LED light source, a single light transmission fiber and two light collecting fibers connected to two different photodetectors at different radial distances from the light transmission fiber; and

FIGS. 5a and 5b schematically illustrate two possible embodiments of light backscatter probes.

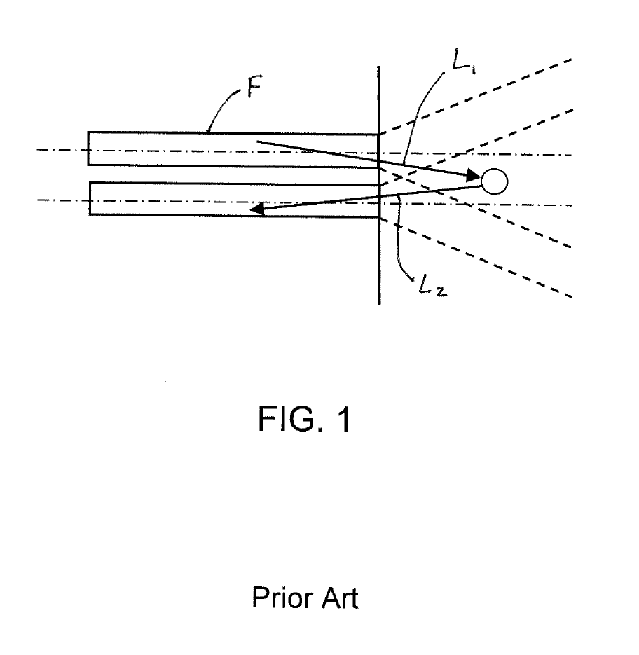

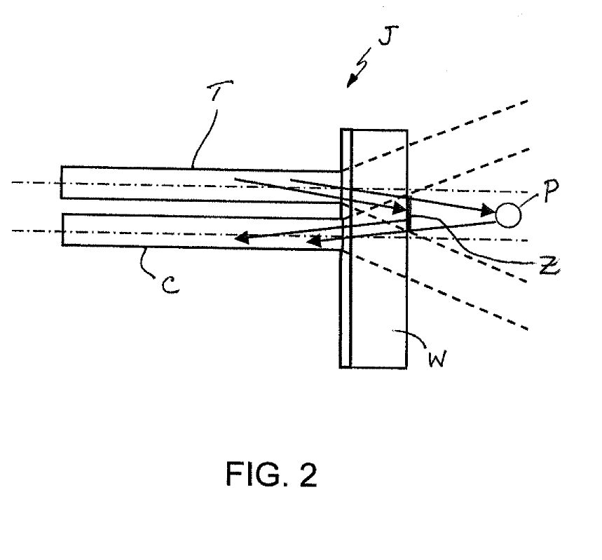

Reference will now be made in detail to the various embodiments of probes, examples of which are illustrated in the accompanying drawings.

### DETAILED DESCRIPTION

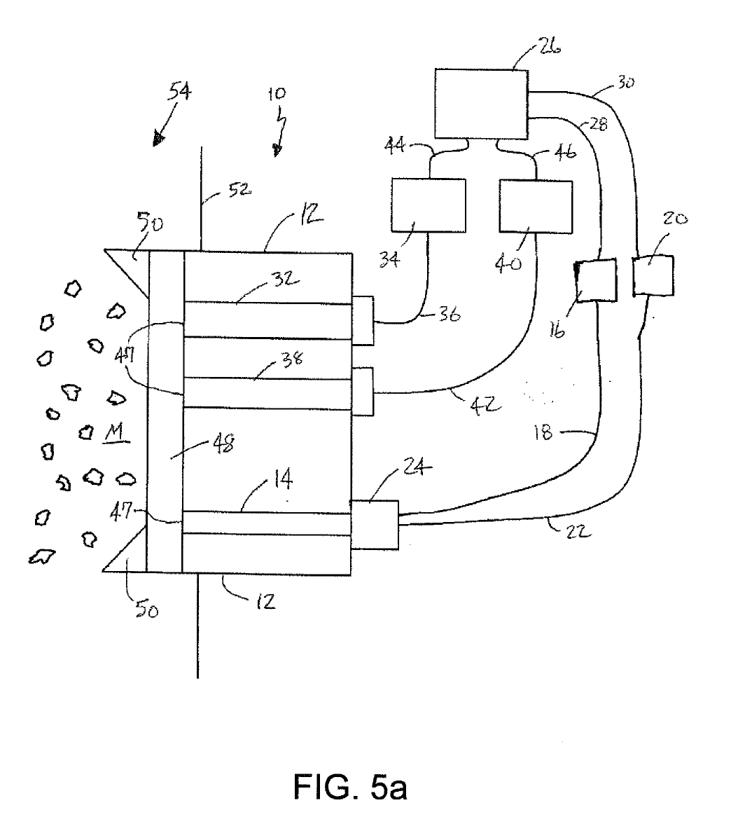

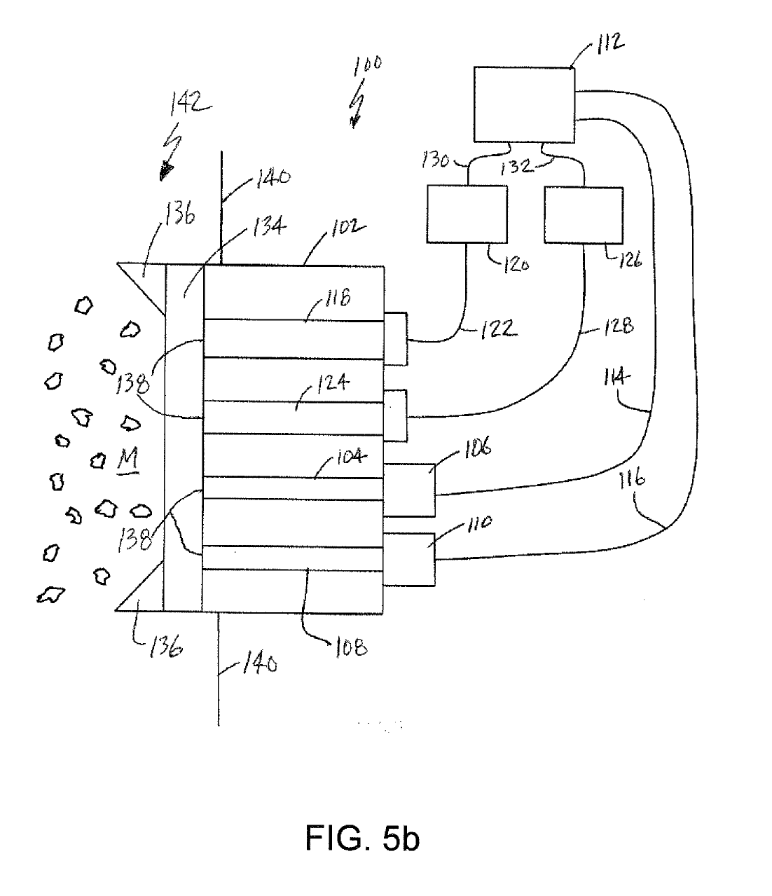

Reference is now made to FIG. 5a schematically illustrating one possible embodiment of a light backscatter probe 10. The probe 10 includes a housing 12 formed of stainless steel or other appropriate food-industry-approved material, that carries a light transmission path 14. The light transmission path 14 may comprise an optical fiber of appropriate diameter and numerical aperture as described below. Useful optical fiber diameters range between 50-1500 microns. The light transmission path 14 is provided in communication with a first light source 16 by means of a first fiber optic line 18 and a second light source 20 by means of a second fiber optic line 22 through a splitter 24. A computing device 26 controls the operation of the first and second light sources 16, 20 by means of the control lines 28, 30.

The first light source 16 and second light source 20 both generate or emit light at a wavelength of between 200 nm and 1100 nm. The wavelengths of the light emitted by the two sources 16, 20, however, differs by at least 20 nm. The two light sources 16, 20 are pulsed at a frequency of between 1 and 1,000 times per second. Thus light is alternatively emitted from one of the light sources 16, 20 and then the other. This pulsed light at two different frequencies allows one to generate more information about the product being monitored than using light of a single wavelength.

The housing 12 also carries a first optical reception path 32 which may also take the form of an optic fiber. The first optical reception path is provided in communication with a first light sensor or photodetector 34 by means of the fiber optic line 26. In addition, the housing 12 also carries a second optical reception path 38 which may also take the form of an optic fiber. The second optical reception path 38 is provided in communication with a second light sensor or photodetector 40 through the fiber optic line 42. Data collected by the photodetectors 34, 40 is supplied to the computing device 26 through the respective lines 44, 46. The computing device 26 may be used to record and analyze the collected light backscatter data in a manner known in the art.

As further illustrated in FIG. 5a the ends 47 of the light transmission path 14, first optical reception path 32 and second optical reception path 38 are all closed by a sapphire window 48 that is secured and held in the housing 12 by a gold braze 50. In order to provide for maximum light intensity and signal strength, the distance from the end of the light transmission path 14 to the product and back to the light reception paths 32, 38 should be minimized. Thus, the sapphire window 48 should be as thin as possible while able to withstand any anticipated operating pressure. Typically the window 48 has a thickness of between 0.1 mm and 2.0 mm. As further illustrated in FIG. 5a, the light backscatter probe 10 may be secured in the wall 52 of a vessel 54 holding coagulating milk M or other product to be monitored.

An alternative embodiment of a light backscatter probe 100 is illustrated in FIG. 5b. The probe 100 includes a housing 102 holding a first light transmission path 104 connected to a first light source 106 and a second light transmission path 108 connected to a second light source 110. The light sources 106, 110 are connected to a computing device 112 by respective control lines 114, 116.

The housing 102 also carries a first optical reception path 118 connected to a first photodetector 120 by means of the fiber optic line 122 and a second optical reception path 124 connected to a second photodetector 126 by a fiber optic line 128. Control lines 130, 132 supply data from the photodetectors 120, 126 to the computing device 112.

A sapphire window 134 is secured to the housing 102 by a gold braze 136 or other appropriate means. As should be appreciated, the sapphire window 134 closes the ends 138 of the first and second light transmission paths 104, 108 and first and second optical reception paths 118, 124. As further illustrated, the probe 100 may be secured in the wall 140 of a vessel 142 holding coagulating milk M or other product to be monitored. The light sources 106, 110 in this second embodiment may correspond to and operate like those light sources 16, 20 described above with respect to the FIG. 5a embodiment.

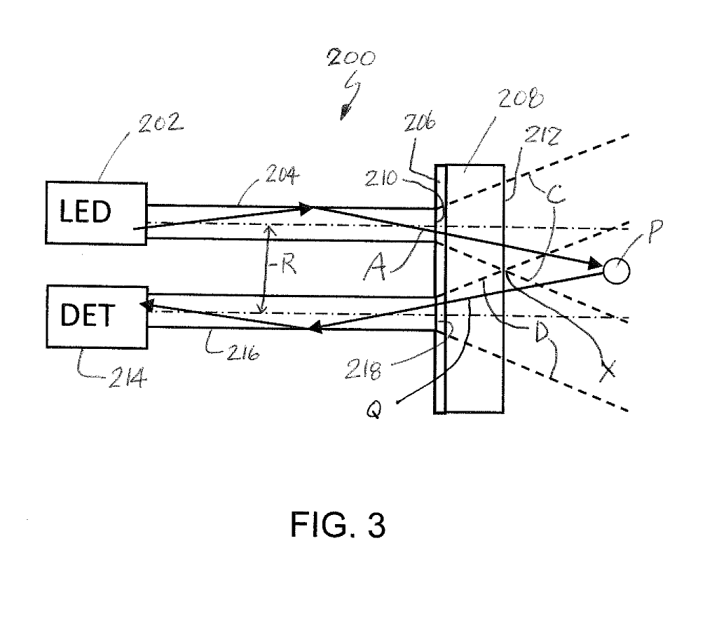

Reference is now made to FIG. 3 illustrating how the probe 10 with a sapphire window is constructed so as to avoid collection of specular reflectance and diffuse reflectance and only collect light backscatter for optimum sensitivity, signal-to-noise ratio and monitoring performance. As illustrated light from a first light source or LED 202 travels through the optical delivery fiber 204 through a layer of optical grease 206 (thickness of grease layer is between 0.025 mm to 0.25 mm) and the sapphire window 208 where it is projected through the product onto a product particle P (not action arrow A). In particular, one should note the cone of light C illustrated by the dashed lines projecting from the end 210 of the optical delivery fiber through the optical grease 206, the sapphire window 208, and the product beyond the product side or face 212 of the sapphire window. Here it should also be noted that the optical path distance through the grease layer 206 and window 208 should be minimized as much as possible. For cheese making applications, the optical path distance is generally between 0.2 mm and 4.0 mm.

As also illustrated in FIG. 3, the probe 200 includes a photodetector 214 in communication with an optical receiving fiber 216 having an end 218. A detection cone D (note dashed lines) extends from the end 218 of the optical receiving fiber 216 through the optical grease 206 and sapphire window 208 into the product, the cone converging toward the optical receiving fiber. Light, backscattered by the particle P travels along the detection cone D through the sapphire window 208, the optical grease 206 and the optical receiving fiber 216 to the photodetector 214 (see action arrow Q).

As should be appreciated, the light cone C and collection or detection cone D define a first point of overlap X outside the sapphire window 208 between 0.0 mm and 1.0 mm and more preferably between 0.0 mm and 0.5 mm from the product side or face 212 of the sapphire window. By providing such a geometry, only backscatter light is collected and sent to the photodetector 214 and specular reflectance and diffuse reflectance are effectively eliminated. This enhances the sensitivity, signal-to-noise ratio and effectiveness of the probe 10. By providing the first point of overlap X of the light cone C and detection cone D immediately at the sapphire window-product interface or just beyond that interface in the product, the radial distance R between the optical delivery fiber 204 and optical receiving fiber 216 may be minimized to provide the highest light intensity and greatest monitoring sensitivity while simultaneously eliminating specular reflectance and diffuse reflectance from the backscatter light being collected. Thus, probe operation is optimized.

The technique used to best accomplish this goal is to use low numerical aperture (NA) fibers 204, 216. The NA of a fiber 204, 216 defines the maximum cone of light that can enter or exit the fiber. The numerical aperture is defined by NA=n sin(θ) where n is the index of refraction of the medium in which the lens is working (1.0 for air, 1.33 for pure water and up to 1.56 for oils), and θ is the half-angle of the maximum cone of light that can enter or exit the lens. Optical fiber having a numerical aperture between 0.12 and 0.26 are common. The cone angle (full angle) of the light exiting a 0.12 NA optical fiber into air is 14 degrees and for a 0.26 NA fiber 30 degrees. Thus, it should be appreciated that the NA can be used to increase or decrease the required separation distance between fibers. The NA of the optical grease (about 1.6) and sapphire window (about 1.5) are different from air. These higher NA's will reduce the cone angle of the light entering the product.

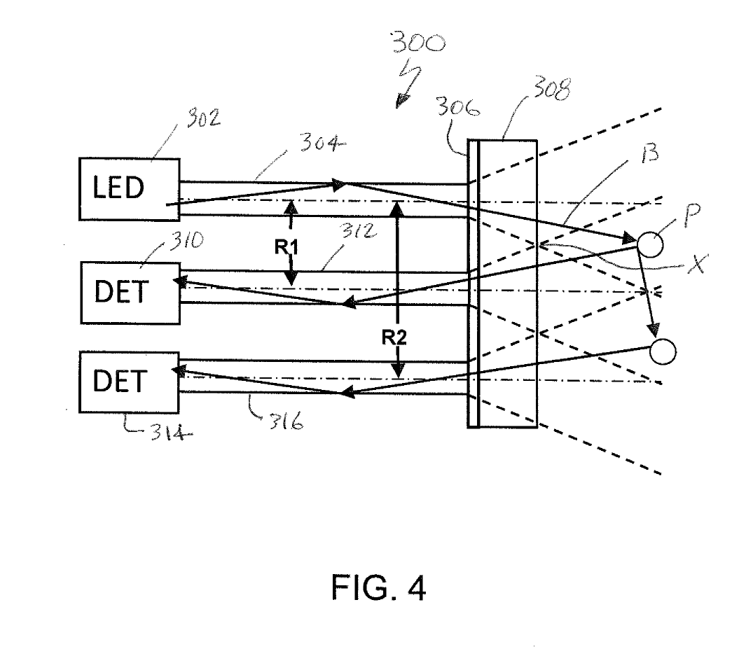

FIG. 4 is a schematic illustration of a light extinction measurement configuration wherein the probe 300 includes an LED light source 302 in communication with an optical delivery fiber 304 for directing light from the source through the optical grease 306 and sapphire window 308 into the product P (note action arrow B).

The probe 300 also includes a first photodetector 310 in communication with a first optical receiving fiber 312 and a second photodetector 314 in communication with a second optical receiving fiber 316. As illustrated, the first optical receiving fiber 312 is spaced the minimum lateral distance r1 from the optical delivery fiber 304 (note first point of overlap X precisely at interface of the sapphire window with the product) while the second optical receiving fiber 316 is spaced a different/greater lateral distance r2 from the optical delivery fiber. By measuring light backscatter at two different locations that are spaced at different distances r1 and r2 from the delivery fiber 304, it is possible to measure light extinction and obtain additional information respecting the product being monitored. This is particularly useful for the determination of product compositions such as the fat content of milk.

More specifically, a relatively simple empirical correlation between the distribution of backscattered light intensity I(r) and the particle concentration is utilized by adapting a widely used diffusion approximation equation presented by Bolt and ten Bosch [1]:

([1] Bolt, R. A. and J. J. ten Bosch. 1993. Methods for measuring position-dependent volume reflection. Appl. Optics 32:4641-4645.)

$$I ( r ) = {I}_{0} \frac{exp ( - β Cr )}{{r}^{m}} \qquad Equation ( 1 )$$

where:

I₀=apparent intensity at radial center line of emitting fiber

I(r)=Light intensity as a function of radial distance from the emitting fiber

β=specific backscatter light coefficient

C=concentration of particulates

m=exponent relating light diffusion in the radial direction

r=radial distance of the receiving fiber (centerline to centerline), mm.

The backscatter light coefficient, β, is based on the ability of the sample to scatter light and depends on the optical and radiative properties of the particles in the sample. The value of m depends on whether the detector is placed in the intermediate area (m=½) or the diffusion area (m=2). The diffusion area is defined as the area in which sufficient multiple scatterings have taken place, so that the diffusion approximation is valid.

In the development of a sensor, the use of signal ratios has the advantage of normalizing the resulting response. This isolates the signal ratio from changes in light intensity and some changes to the physical system (optics, mechanical connections, etc.). For the fully developed diffusion area, the ratio of the intensities at two radial distances (r1 and r2) using Equation (1) reduces to the following equation:

$$\frac{I ( {r}_{1} )}{I ( {r}_{2} )} = {( \frac{{r}_{2}}{{r}_{1}} )}^{m} exp ( β C ( {r}_{2} - {r}_{1} ) ) \qquad Equation ( 2 )$$

where r1 and r2 are radial distances for fiber 1 and fiber 2, respectively, and C is a constant of a scattering particle. This equation predicts an increasing signal ratio with increasing particle concentration. Light scattering is dominant for high concentrations of fat and the widely used diffusion approximation is valid for this case.

Light extinction measurements have been tested on several products: fat content in cream, fat content in milk, and degree of homogenization of fat in meat emulsion manufacturing (hot dogs for example).

Reference is now made to the following examples which further illustrate the invention.

### Example 1

A probe was made with metal coated fiber optics to prevent crosstalk between the fibers. The fibers used for the transmission of incident light and the collection of backscatter light had an outer diameter of 287 microns. The fiber core was 200 microns, cladding 220 microns in diameter. The fibers had a numerical aperture of 0.12 that reduced the cone spread of light and minimized the distance between the delivery fiber and the receiving fiber. The thickness of the optical grease was 127 microns with a numerical aperture of 1.6. The thickness of the sapphire window was 635 microns with a numerical aperture of 1.5. The diameter of the cone of the light increased from 200 microns at the fiber optical grease interface to 219 microns at the optical grease-sapphire window interface to 260 microns at the sapphire window-product interface. Consequently the minimum separation distance between the centerline of the delivery fiber and the centerline of the receiving fiber in order to avoid specular and diffuse reflectance was 260 microns. This was smaller than the fiber diameter with the metal cladding of 287 microns. Consequently the metal clad fibers were packed beside each other. If the metal clad was not present then the fibers would had a diameter of 220 microns and a 40 micron space would need to be provided between the fibers in order to maximize the signal strength of the backscatter light while still eliminating specular reflectance and diffuse reflectance.

### Example 2

A probe is made with transmission and receiving fibers having a 0.22 numerical aperture. The cone diameters at the fiber-grease, grease-sapphire and sapphire-product interfaces are 200, 235 and 423 microns respectively. As a consequence, in order to avoid specular and diffuse reflectance the minimum separation distance for the delivery and receiving fibers using the numerical aperture 0.22 fiber is 423 microns. Since the fiber has a diameter with cladding of 287 microns then there must be a 137 micron space between the fibers.

The foregoing has been presented for purposes of illustration and description. It is not intended to be exhaustive or to limit the embodiments to the precise form disclosed. Obvious modifications and variations are possible in light of the above teachings. For example, while the probe and method are described as being used to monitor the coagulation of milk in the cheese making process, they could be used to monitor and measure other compositions and products as desired. All such modifications and variations are within the scope of the appended claims when interpreted in accordance with the breadth to which they are fairly, legally and equitably entitled.

What is claimed:

1. A light backscatter probe, comprising:
a housing;
at least one optical transmission path carried on said housing;
a first optical reception path carried on said housing;
a second optical reception path carried on said housing;
a first light source in communication with said at least one optical transmission path;
a second light source in communication with said at least one optical transmission path;
a first photodetector in communication with said first optical reception path; and
a second photodetector in communication with said second optical reception path;
said probe being further characterized by said first and second optical reception paths being located different radial distances from said at least one optical transmission path on said housing.

2. The probe of claim 1 further including a computing device to collect and analyze backscatter data.

3. The probe of claim 1, wherein said first light source generates light at a first wavelength, said second light source generates light at a second wavelength and said first and second wavelengths differ.

4. The probe of claim 3, wherein said first and second wavelengths are between 200 nm and 1100 nm.

5. The probe of claim 4, wherein said first and second wavelengths differ by at least 20 nm.

6. The probe of claim 5, wherein said first and second light sources are alternately pulsed at a frequency of between 1 and 1,000 times per second.

7. The probe of claim 1, further including a sapphire window carried on said housing, said window closing ends of said at least one optical transmission path, said first optical reception path and said second optical reception path.

8. The probe of claim 7, wherein said sapphire window is gold brazed to said housing.

9. The probe of claim 6, wherein said at least one optical transmission path includes a first light transmission fiber connected to said first light source and a second light transmission fiber connected to said second light source.

10. The probe of claim 1, further including a vessel and coagulating milk in said vessel, said housing being oriented relative to said vessel so that light transmitted from said first and second light sources through said at least one optical transmission path impinges on said coagulating milk in said vessel and light backscattered by said coagulating milk is collected by said first and second optical reception paths and delivered to said first and second photodetectors.

11. A method of monitoring or determining product compositions, comprising:
impinging a first light at a first wavelength onto said product;
detecting light backscatter from said product at said first wavelength at two different positions where said two different positions are different distances from a first point of transmission of said first light;
impinging a second light at a second wavelength onto said product; and
detecting light backscatter from said product at said second wavelength at two different positions where said two different positions are different distances from a second point of transmission of said second light.

12. The method of claim 11 wherein said product is coagulating milk, said method including analyzing backscatter data and predicting cut time for said coagulating milk.

13. The method of claim 12, including impinging and detecting through a sapphire window.

14. The method of claim 11 including using a single, optical transmission path so that said first and second transmission points are the same.

15. The method of claim 11, including using two separate optical transmission paths so that said first and second transmission points are different.

16. A method of monitoring or determining composition of a product, comprising:
pulsing light on the product at two different wavelengths; and
detecting backscatter of said pulsed light at two different radial distances from a point of transmission of said pulsed light.

17. The method of claim 16 wherein said product is coagulating milk, said method including analyzing backscatter data and predicting cut time for said coagulating milk.

18. The method of claim 16, including pulsing and detecting said light through a sapphire window.

19. The method of claim 16, including using a first light at a first wavelength of between 200 nm and 1100 nm and using a second light at a second wavelength of between 200 nm and 1100 nm where said first and second wavelengths differ by at least 20 nm.

20. The method of claim 19, including pulsing said lights at differing wavelengths at a frequency of between 1 and 1,000 times per second.

21. A light backscatter probe for monitoring or measuring composition of a product, comprising:
a housing carrying a first light transmission fiber and a first light collecting fiber;
a light source in communication with said first light transmission fiber;
a photodetector in communication with said first light collecting fiber; and
a sapphire window carried on said housing, said sapphire window closing ends of said first light transmission fiber and said first light collecting fiber;
wherein said first light transmission fiber projects a light cone through said sapphire window into said product and said first light collecting fiber collects backscatter light from said product in a detection cone passing through said sapphire window and converging toward said first light collecting fiber with said first light transmission fiber and said first light collecting fiber oriented so that said light cone and said detection cone define a first point of overlap on a product side of said sapphire window.

22. The probe of claim 21 wherein said sapphire window includes a product face which contacts the product being monitored and said first point of overlap is between 0.0 mm and 1.0 mm from said product face.

23. The probe of claim 21 wherein said sapphire window includes a product face which contacts the product being monitored and said first point of overlap is between 0.0 mm and 0.5 mm from said product face.
